(19) United States
(12) Patent Application Publication
(10) Pub. No.: US 2010/0216478 A1
(43) Pub. Date: Aug. 26, 2010

(54) Method and apparatus for operating a communications arrangement comprising femto cells

(76) Inventors: Milind M Buddhikot, Manalapan, NJ (US); Irwin O Kennedy, Londonderry (IE); Francis Joseph Mullany, Drimnagh (IE); Harish Viswanathan, Morristown, NJ (US)

Correspondence Address: Alcatel-Lucent, Docket Administrator, Room 2F-192, 600-700 Mountain Ave., Murray Hill, NJ, 07974-0636, US

(21) Appl. No.: 12/378,823

(22) Filed: Feb. 20, 2009

(51) Int. Cl. H04W 72/00; H04L 27/28

(52) U.S. Cl. 455/450; 375/260

(57) ABSTRACT

A method for operating a communications arrangement comprising femto cells includes opportunistic use of the spectrum by a femto cell. The method may involve multi-operator spectrum re-use and/or multi-service spectrum re-use. The femto cell may use parts of the spectrum when they are not used by primary license holders. A femto base station 12 includes a spectrum decision unit 20 for using information about primary usage to determine operation of the femto base station 12 to achieve opportunistic re-use.

### FIELD OF THE INVENTION

The present invention relates to a method for operating a communications arrangement including femto cells.

### BACKGROUND

Recent years have seen explosive growth in wireless services worldwide. In addition to reliable, ubiquitous coverage, wireless end-users now increasingly expect high throughput data services. Third Generation (3G) broadband wide-area cellular services, such as HSDPA/HSPA and EV-DO Rev A, represent the first step in meeting this expectation. However, as these services gain widespread adoption, the next generation of wireless services must evolve to ultra-broadband (multi-megabits/sec/user) speeds. Two core and complementary approaches to improving wireless speeds are: (a) aggressively reuse the spectrum in the most efficient fashion, and (b) increase the amount of spectrum available for use.

Recently, large service providers have started considering femto cells, which are cells with small spatial footprint, deployed for example in homes, enterprise buildings and public places, as a tool to aggressively utilize their expensive licensed spectrum to its maximum extent. The femto cells therefore represent approach (a) mentioned above.

The first generation of femto cell deployments will use spectrum by static allocation or by concurrent co-channel reuse. For the former option, the femto cells use a statically reserved portion of the spectrum that is not used in macro-cells. In the concurrent co-channel reuse approach, the femto cells reuse concurrently the same spectrum used by macro-cells.

Technical challenges in the design of the first generation femto cells have been addressed in recent research results, for example, see H. Claussen, “Performance of Macro and Co-channel Femtocells in a Hierarchical Cell Structure”, Proceedings of IEEE Symposium on Personal, Indoor and Mobile Radio Communications, (PIMRC 2007); and L. Ho, “Effects of User-deployed, Co-channel Femtocells on the Call Drop Probability in Residential Scenario”, Proceedings of IEEE Symposium on Personal, Indoor and Mobile Radio Communications (PIMRC 2007).

### BRIEF SUMMARY

According to a first aspect of the invention, a method for operating a communications arrangement comprising femto cells includes opportunistic use of the spectrum by a femto cell. Opportunistic use is when secondary, unlicensed, users make use of part of a spectrum when it is not being used by primary users, that is, by licensed users of a specific band. It is important that opportunistic use does not degrade the service experienced by primary users. By using a method in accordance with the invention, it may be possible to achieve femto cell deployments that enable ultra-broadband wireless access (10 s of Mbps/user).

In a method in accordance with the invention, opportunistic use includes at least one of: multi-operator spectrum re-use; and multi-service spectrum re-use. In multi-operator spectrum re-use, femto cells use the spectrum that is owned by multiple cellular service providers and/or operators, such as Verizon, Sprint, T-mobile, in a region. In multi-service spectrum re-use, femto cells use spectrum licensed to other services such as, for example, television, Public-safety, and Specialized Mobile Radio (SMR)/Land Mobile Radio (LMR) or other types of service. In this specification, multi-operator and multi-user reuse are also referred to as secondary spectrum reuse.

Multi-operator and/or multi-service spectrum reuse in femto cells may contiguously or non-contiguously use the spectrum, or may involve a combination of contiguous and non-contiguous usage.

Multi-operator and/or multi-service spectrum reuse in femto cells, in an embodiment of the invention, permits wider bands of spectrum to be available to allow wideband air interface technologies to be exploited. Emerging new air interfaces for wide area cellular technologies such as WiMAX (ranging from 1.75 to 20 MHz), EV-DO rev B (1.25 MHz to 20 MHz) and LTE (1.75 MHz to 20 MHz) require wider spectrum bands for higher data rates. By using an embodiment of the invention, such wider bands may be made available for low power use in femto cells.

In a method in accordance with the invention, information is collected from multiple operators regarding their spectrum utilization; and the spectrum utilization information is used to determine available spectrum for opportunistic use by the femto cell. For example, signal strength measurement information may be collected from multiple operators, and the signal strength measurement information used to determine available spectrum for opportunistic use by the femto cell. The information may include location information where this is required to make the determination.

In a method in accordance with the invention, spectrum measurements are made and used to obtain information regarding short term spectrum usage by primary licence holders to determine available spectrum for opportunistic use by the femto cell.

Measurements for use in determining what opportunistic use is potentially available may, for example, make use of measurements taken by femto base stations, user handsets or some other mechanism, or by various combinations of these approaches. A server, which may be centralized or which may involve a plurality of spatially remote units that co-operate, for example, may be used to co-ordinate measurements used in determining potential opportunistic usage, for example, by organizing measurements taken at different locations and/or at different times.

According to a second aspect of the invention, a femto base station for supporting a femto cell is configured to provide opportunistic use of the spectrum by the femto cell. The femto base station may comprise a spectrum decision processor for using information from multiple operators regarding their spectrum utilization to determine available spectrum for opportunistic use by the femto cell. The femto base station may comprise an air-interface between an end user and the femto cell, the air-interface using non-contiguous orthogonal frequency-division multiplexing (NC-OFDM). The femto cell may be configured to opportunistically re-use non-contiguous frequency blocks of a macrocellular narrowband network overlaying the femto cell, such as, for example, 2G TDMA network.

According to a third aspect of the invention, a multi-operator spectrum server, for use with a femto base station for supporting a femto cell and configured to provide opportunistic use of the spectrum by the femto cell, comprises: a collector configured to collect information about use of spectrum by multiple operators; and a processor for using the collected information to determine the aggregate spectrum available for opportunistic reuse by the femto cell; and a communicator for communicating the determination to permit opportunistic use of the spectrum by the femto base station. The communicator may communicate the determination to at least one of the femto base station and a femto controller. The server may comprise a spectrum assessor for using information from a plurality of femto base stations to derive dynamic inferences about spectrum usage and availability.

According to a fourth aspect of the invention, a femto controller for coordinating operation of a plurality of femto base stations of an operator comprises: a coordinator for coordinating opportunistic spectrum usage by femto cells supported by the plurality of femto base stations; and a server for providing information to a femto base stations including at least one of: spectrum usage of neighboring femto cells; power levels of neighboring femto cells; locations of macro-cell base stations; and transmitters of primary users.

According to a fifth aspect of the invention, a spectrum usage decision processor, for use with a femto base station for supporting a femto cell, to determine available spectrum for opportunistic use by the femto cell, comprises using in the determination at least one of information about: type of primary user; type of primary user signals; locations of primary user transmitters; localized spectrum sensing to detect presence or absence of primary transmissions and/or presence of other secondary femto cells; information from other sensors or neighbor femto base stations on their real-time measurements spectral energy present in a band; signal specific characteristics; and detection of known signatures. The spectrum usage decision processor may be a unit included in a femto base station. The processor may comprise a mapper to provide a spectrum band null map.

### BRIEF DESCRIPTION OF THE DRAWINGS

Some embodiments of the present invention will now be described by way of example only, and with reference to the accompanying drawings, in which:

FIG. 1 schematically illustrates multi-operator sharing;

FIG. 2 schematically illustrates multi-service spectrum reuse.

FIG. 3 schematically illustrates an arrangement in accordance with the invention;

FIG. 4 schematically illustrates collaborative sensing;

FIG. 5 is a schematic exemplary diagram illustrating operation of a spectrum usage detection unit;

FIGS. 6(a) and 6(b) schematically illustrates frequency reuse in a network; and

FIG. 7 schematically illustrates an embodiment of the invention relating to white space spectrum for GSM and digital television usage.

### DETAILED DESCRIPTION

With reference to FIG. 1, multi-operator spectrum reuse in femto cells is illustrated using an example which shows macro-cellular networks 1, 2 and 3 of three providers Verizon, T-Mobile, and Cingular with corresponding cellular/PCS spectrum license assignments in a region 10 sq. km around Murray Hill, N.J. Here, Verizon owns spectrum block B in cellular band. (Note: cellular band in USA: 825-849 MHz (Uplink), 870-894 MHz (Downlink), both split into blocks A and B) and owns PCS band blocks C and F. (Note: PCS bands in USA: (1850-1910 MHz (Uplink) 1930-1990 MHz (Downlink), both split into six blocks A to F). Cingular/AT&T owns cellular block A and PCS block A; and T-Mobile owns PCS block D.

Under the previously existing licensing regime, femto cells 4, 5 and 6 deployed in the network of each provider are permitted to use only the specific licensed spectrum of that provider. As an example, Verizon femto cells 4 can use only cellular block B and PCS blocks C and F. In an embodiment in accordance with the invention, with multi-operator sharing, each femto cell 4, 5 and 6 of every provider has access to full PCS and Cellular bands. In the example shown in FIG. 1, the Verizon femto cells 4 is permitted to use cellular Block A, PCS block A from Cingular and PCS block D from T-Mobile in addition to Verizon's own cellular block B.

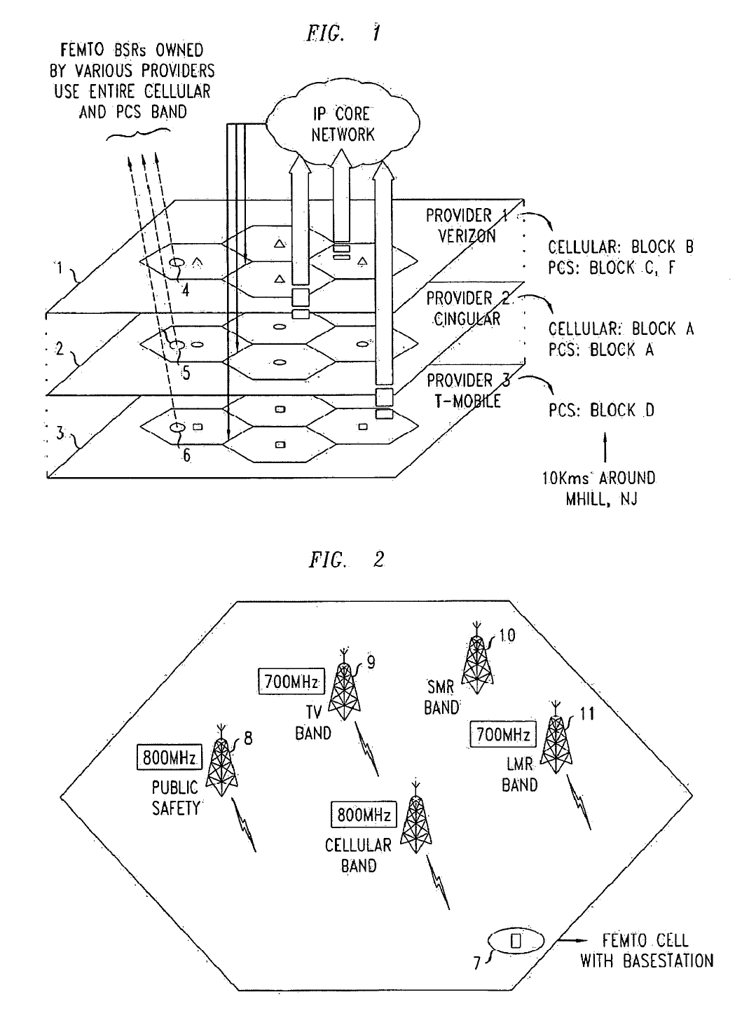

FIG. 2 illustrates the concept of multi-service spectrum reuse. In this embodiment of the invention, a femto cell 7 attempts to opportunistically use the spectrum of multiple services, specifically Public-safety 8, broadcast TV 9, SMR 10 and LMR 11 bands. In the USA, these services have spectrum allocated in the 700-900 MHz spectrum bands. Thus, extending to multiple services significantly increases the spectrum pool available for femto use to excess of 300 MHz.

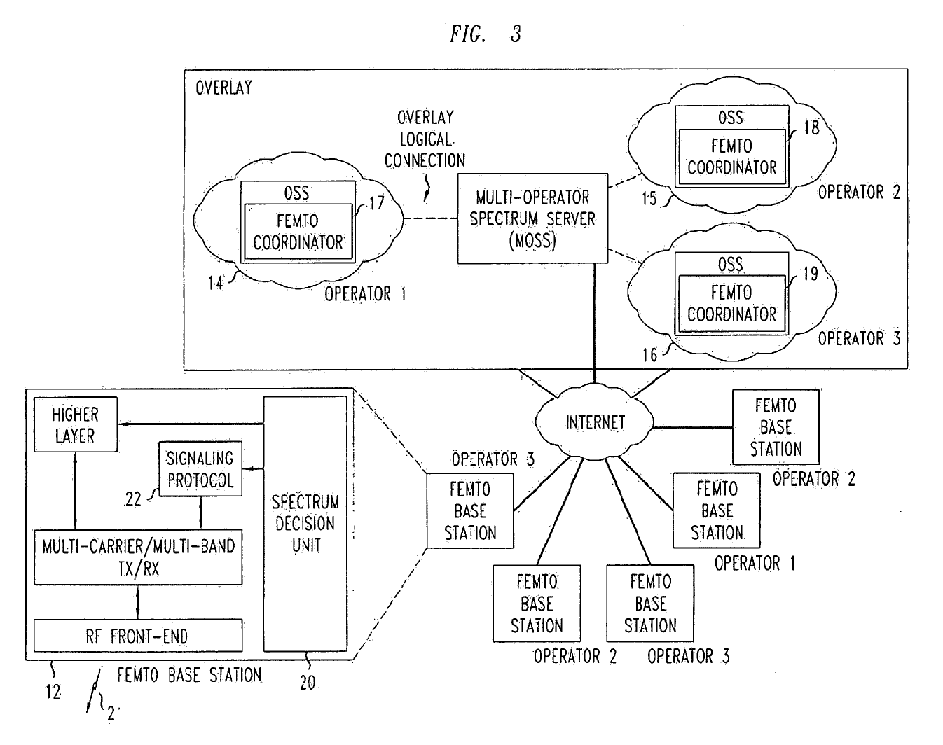

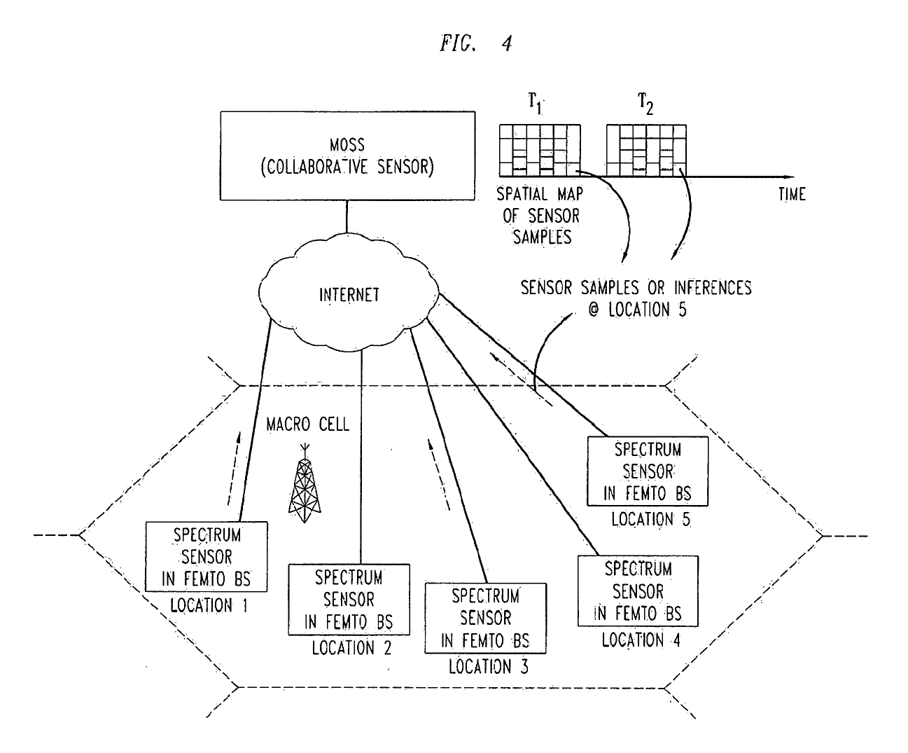

With reference to FIG. 3, an arrangement in accordance with the invention includes a femto base station 12 supporting a femto cell. A network resident server, termed a Multi-operator Spectrum Server (MOSS) 13, collects spectrum utilization information, and optionally signal strength measurement information, from multiple operators 14, 15 and 16, and determines what spectrum is available for use in femto cells, such as femto cell 7, in a particular spatial region. A Femto Coordination or Controller Server (FCS) 17 to 19 is a network resident server deployed in the Operations Support System (OSS) of each operator 14 to 16, and provides coordination and control of the respective operator's femto base stations. An FCS may act as a registration, authentication and auto-configuration server. It coordinates opportunistic spectrum usage by providing a range of information to femto base stations, such as, for example, spectrum usage and power levels of neighboring femto cells, locations of macro-cell base stations or transmitters of primary users based on collective information received from the MOSS 13.

The MOSS 13 coordinates the use of spectrum across multiple operators and informs the Femto controller/Femto cell of each operator of the aggregate spectrum available for femto cell use in each region. The MOSS 13 may collect information about spectrum availability for femto use from each operator and, for example, optionally combine it with additional spectrum measurement information received from one or more operating femto cells. The MOSS 13 may also, in some embodiments, perform collaborative spectrum sensing by processing spectrum sensing information from various femto base stations to draw dynamic inferences about spectrum usage and availability, as illustrated in FIG. 4. The spectrum availability as determined by the MOSS 13 may be time-varying in addition to being location dependent.

A Spectrum Usage Decision Unit (SUDU) 20 is located at the femto base station 12. It processes information about primary spectrum usage and makes decisions, based on information available to it, on portions of spectrum, called “spectrum white spaces”, which are not in use by a primary license holder and, therefore, are available for use by the femto cell for transmissions. The decisions made at the SUDU 20 may be based on, for example, combining long-term and medium term spectrum usage by the primary users, obtained from the MOSS 13 and the FCS 17 to 19, with, in this embodiment, short term spectrum usage being obtained by local and/or remote spectrum measurements. In some embodiments, only one of long, medium and short term spectrum usage may be taken into account but using two or more is advantageous.

The femto base station 12 has an air interface 21 that operates in non-contiguous spectrum bands to enable communication between an end-user and the femto base station 12. It also employs a signaling protocol 22 that informs end users about the spectrum over which data is transmitted and also may provide other coordination functions, for example, power control.

With spectrum sharing, it is possible that the spectrum that is available for use is a non-contiguous set of carriers, and possibly even in different bands. To achieve high data rates, it may be necessary to transmit data over multiple carriers using an air-interface technology designed for that carrier in that band. For example, if multiple 1.25 MHz carriers in a CDMA system are available, multi-carrier CDMA signaling in which base band signals are separately generated for each carrier, modulated to the appropriate carrier and then combined must be used.

In recent years, classical orthogonal frequency-division multiplexing (OFDM), a frequency domain modulation technique using sub-carriers that are contiguous in frequency space, has emerged as a preferred air-interface for several state-of-the-art technologies, such as WiMAX, 3GPP LTE and 3GPP2 UMB. Such an air-interface may be modified to a variant called non-contiguous OFDM (NC-OFDM) which allows sub-carriers to be separated in frequency space. In one embodiment of the invention, the context of opportunistic use, NC-OFDM can selectively turn off the sub-carriers in portions of the spectrum where primary signal or interference is strong. The selective on/off feature may also be applied to control aggregate interference to certain type of primary signals, for example, CDMA.

As mentioned above, the SUDU 20 determines what spectrum to use for transmission. It may use information from multiple sources to make this decision. It may use information from FCS 17 to 19 and MOSS 13. The femto base station 12 uses connections to FCS 17 to 19 and MOSS 13 to obtain information about, for example, the type of primary users, type of their signals and locations of their transmitters present in various spectrum bands. As an example, a femto base station using only a cellular operator spectrum scans the entire 800 MHz cellular and 1.9 GHz PCS bands and uses FCS 17 to 19 and the MOSS 13 to ascertain the location of the macro-cell base station. The femto base station may also use localized spectrum sensing. For example, the SUDU 20 may perform localized measurements to detect the presence or absence of primary transmissions and possibly also the presence of other secondary femto cells. The femto base station may also receive information from other sensors or neighbor femto base stations about their real-time measurements. Measurements may also be obtained from handsets or other mobile stations making use of the network. Detection may be based on a combination of techniques such as the spectral energy present in the band, signal specific characteristics such as cyclo-stationary features and primary signal specific information, for example, DTV pilot, GSM frame structure, CDMA pilots and such like. Detection of signals from nearby secondary femto base stations may also be based on known signatures, for example, an OFDM signature, if an OFDM air-interface is used in a femto cell. Measurements from the SUDU 20 may also be supplied to the MOSS 13. The MOSS 13 may perform better-informed decisions by correlating measurements received from multiple femto cells and multiple SUDUs. The spectrum white space, or availability, information may then be communicated back to the SUDU 20 from the MOSS 13 over the wireline backhaul connection. The information may also be sent to an FCS, which uses it in determining what spectrum is available to femto cells it controls.

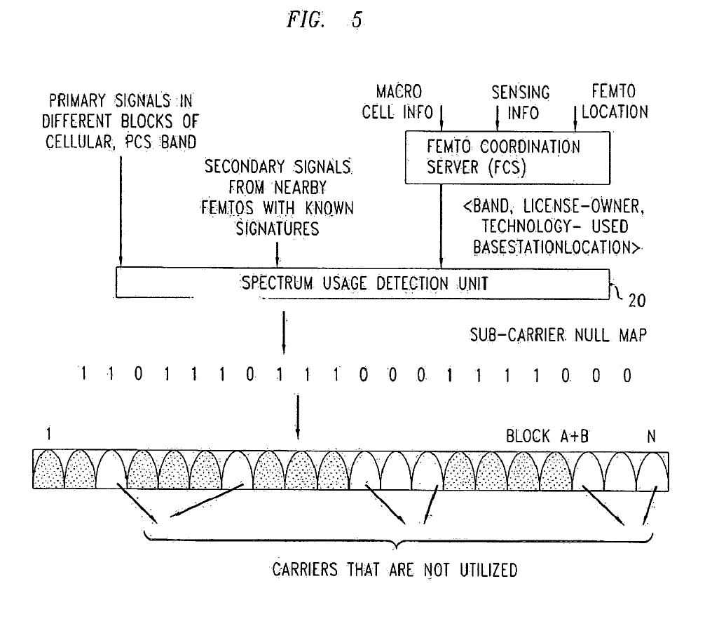

With reference to FIG. 5, the SUDU 20 acts as a mapper using information at its disposal to periodically provide a spectrum band null map, which contains band specific numbers which can be 0, 1 or a (range-limited (<100)) positive number called strength-number. In the context of the NC-OFDM air-interface, this map is called sub-carrier null map where the resolution of the map equals the sub-carrier separation. Number 0 in the map indicates that the band/sub-carrier is not used by primary user and is available for use by the femto cell. Number 1 indicates that femto should not attempt to use the specified band. A non-unit positive number indicates extent of primary user's activity, expressed as a fraction less than 1 multiplied by 100, which may be used in threshold based schemes for deciding if the femto base station should use a spectrum band. The sub-carrier null map is used by the NC-OFDM transmitter to decide which sub-carriers to activate and which ones to null.

The available bandwidth is coordinated between end-user devices and the femto base station 12 using a signaling protocol implemented at 22. The protocol supports appropriate control channels to convey multi-carrier system specific parameters within the network. It may also include other standard information such as power control, pilot, paging, messaging, synchronization and any other auxiliary information. It may also support bi-directional channel between the base station and the end-user device to enable bi-directional signaling.

In one embodiment of this invention, the use of NC-OFDMA for femto cells is combined with 2G narrowband TDMA (such as, for example, GSM, IS-136) macro-cell networks. Owners of 2G spectrum worldwide are expected to gradually migrate to 4G OFDMA-based air interfaces such as 3GPP LTE and 3GPP2 UMB (Ultra Mobile Broadband.) The current plan considered by spectrum regulators, especially in Europe, is to refarm the GSM spectrum by allocating gradually increasing blocks of spectrum to these new air interfaces, vacating the same spectrum as that of the current 2G transmitters. In this embodiment of the invention, NC-OFDMA femtocell base stations and their associated mobile terminals use existing, generally non-contiguous, frequency blocks that are locally free in any given cell due to the TDMA frequency reuse patterns with reuse factor greater than 1. To prevent excessive interference, the narrow-band carriers in a given 2G macro-cell are those that are not used in nearby cells. This leaves many unused carrier frequencies in any given cell. However, femto cell base stations may safely reuse these frequencies due to their low transmit powers, low path loss to mobiles camped on the femto cell, and high degree of isolation to the outdoor macro-cells due to wall attenuation. Thus, 4G femtocell operation may begin without a global vacating of particular frequency blocks. Non-contiguous operation is beneficial in that it allows opportunistic maximal use of the locally free spectrum blocks, irrespective of which combination of frequencies carriers are being used in the local macro-cell.

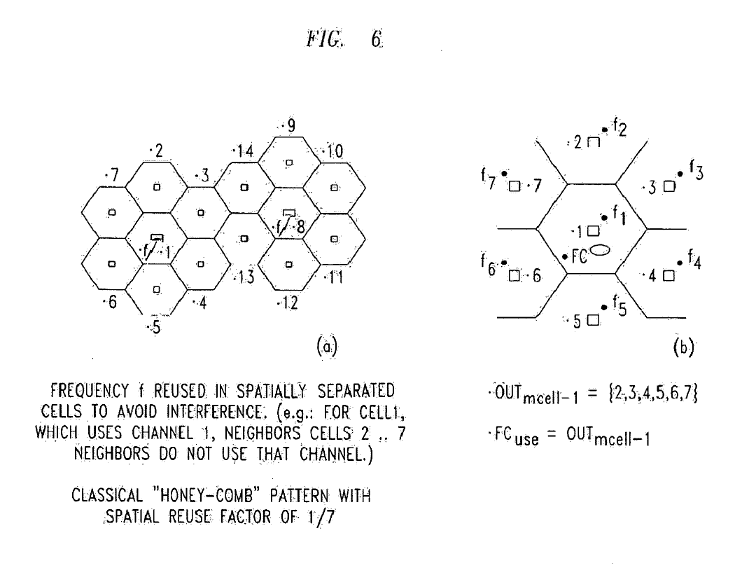

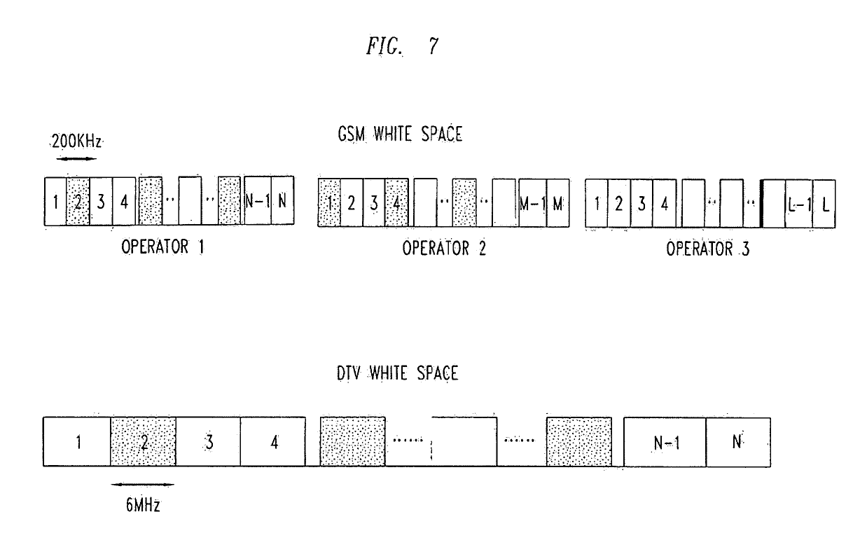

With reference to FIGS. 6(a) and 6(b), the TDMA-based physical layer technology used in GSM networks dictates what fraction of total spectrum can be employed in each cell, which results in a spatial reuse pattern that is characterized by a parameter called frequency reuse factor k. The interference constraints dictate that a channel that is used in a given cell can be reused in another physically distant cell. The example shows a cell layout with a reuse factor of 1/7, where channel f used in cell 1 cannot be used in neighbors {2 . . . 7} and can be reused in cell 8. Consider a femto cell FC embedded in cell 1. The frequencies {f₂, . . . f₇} used in the macro-cells 2 to 7 are not used in cell 1 and can be safely reused in FC.

The low transmit power in FC, low path loss to mobiles camped in it and high degree of isolation to the outdoor macro-cells due to wall attenuation allows such reuse. With N channels and a reuse factor of 1/K, N/K channels are used in each cell and as such an FC can potentially use [(N)(K−1)/K] channels as white space. A GSM operator therefore can deploy femto cells that can aggressively opportunistically use a large part of its own licensed spectrum, making use of the licensed spectrum for unlicensed use or uses. For example, in USA, an operator with license to block A or B in cellular band has maximum 12.5 MHz at it disposal. With a 1/7 reuse, each FC can have maximum ˜10.7 MHz for such reuse.

The femtocell base station 12 can determine what frequency blocks are locally available through one of several methods. In a simple case of reusing a single operator's spectrum in the femto cell, the femto cell base station 12 may report its location to the FCS 17 to 19 and the FCS 17 to 19 then can determine from the macro cell frequency map what frequencies are not used in the location of the femto cell. In a more advanced technique, the information supplied by the FCS 17 to 19 is correlated with measurements performed by the SUDU unit 20 in the femto base station 12 to enhance the decision on locally available spectrum blocks. The MOSS 13 aids, as outlined above, in sharing GSM spectrum across multiple operators.

Examples of where methods in accordance with the invention may be implemented are illustrated with reference to FIG. 7, which shows spectrum white spaces for GSM and digital television (DTV) usages. Traditionally, spectrum allocated under licensed or unlicensed models consists of contiguous chunks. However, the spectrum white spaces will often present non-contiguous spectrum bands. For GSM white spaces, each sub-carrier is 200 kHz and the sub-carriers active in the macro-cell covering a given location are not necessarily contiguous. Also, the frequency hopping pattern used to combat multi-path effects periodically changes the set of in-use and un-used sub-carriers in a macro-cell and therefore, the white space available to a femto cell. When white space spectrum of multiple GSM operators is combined, the aggregate spectrum may exhibit significant non-contiguity, as shown in FIG. 7. For DTV, in most markets, channels adjacent to in-use DTV channels are vacant. This means that the white space channels, each 6 MHz in width, are at least separated by 6 or more MHz. The contiguity of multiple white spaces has implications on the design of air-interface used to exploit white spaces. Unlike the spectrum used for cellular networks which is licensed for very large durations, for example, for 10 year periods in the USA, and over large spatial regions, for example, national or regional scope, availability of white space channels varies spatio-temporally. For GSM, available white space has a scope limited to a macro-cell and it changes predictably with hopping pattern. In case of DTV, the FCC TV channel allocation table varies from place to place and the asynchronous use of unused TV channels by wireless microphones can change a channel from white space to in-use channel in an unpredictable fashion. Most of today's service providers are averse to offering services in spectrum that does not have rigid guarantees in terms of long-term availability and controlled interference environment. The statistical nature of white spaces needs a simple-to-understand characterization to ease their adoption in cellular networks of today. Given their small spatial footprint, femto cells are ideally suited to tolerate this statistical variation.

For intra-operator white space re-use and multi-operator spectrum sharing, end-user handsets and femto base stations operate in the same RF bands as the macro-cell and therefore, may be realized using present-day RF and systems technology. However, for multi-service white space opportunistic reuse, RF front ends should advantageously be capable of tuning over wider bands of RF spectrum ranging from 400 to 900 MHz. The widespread availability of Qualcomm's MediaFlo handsets that operate in channel 55 (lower 700 MHz block) and also support 800 MHz/1.9 GHz cellular/PCS networks suggests RF components that operate in this range can be cost-effectively integrated in handsets and base stations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method for operating a communications arrangement comprising femto cells and including opportunistic use of the spectrum by a femto cell.

2. The method as claimed in claim 1 and wherein opportunistic use includes at least one of: multi-operator spectrum re-use; and multi-service spectrum re-use.

3. The method as claimed in claim 2 and including: collecting from multiple operators information regarding their spectrum utilization; and using the spectrum utilization information to determine available spectrum for opportunistic use by the femto cell.

4. The method as claimed in claim 2 and wherein at least one of multi-operator spectrum re-use and multi-service spectrum re-use involves non-contiguous re-use of the spectrum.

5. The method as claimed in claim 2 and wherein at least one of multi-operator spectrum re-use and multi-service spectrum re-use involves contiguous re-use of the spectrum.

6. The method as claimed in claim 3 and including collecting signal strength measurement information from multiple operators; and using the signal strength measurement information to determine available spectrum for opportunistic use by the femto cell.

7. The method as claimed in claim 1 and including making spectrum measurements and using the spectrum measurements to obtain information regarding short term spectrum usage by primary licence holders to determine available spectrum for opportunistic use by the femto cell.

8. The method as claimed in claim 1 and wherein a femto base station makes measurements used in determining available spectrum for opportunistic use by the femto cell.

9. The method as claimed in claim 1 and including a mobile station making measurements used in determining available spectrum for opportunistic use by the femto cell.

10. The method as claimed in claim 1 and wherein measurements are used in determining available spectrum for opportunistic use by the femto cell and a server coordinates the measurements that are made for at least one of spatially distributed locations and at different times.

11. The method as claimed in claim 1 and including providing at least one of: a multi-carrier; and a multi-band air-interface between an end user and the femto cell.

12. The method as claimed in claim 1 and including providing an air-interface between an end user and the femto cell, the air-interface using non-contiguous orthogonal frequency-division multiplexing (NC-OFDM).

13. The method as claimed in claim 12 and wherein sub-carriers are controlled such that:
in portions of the spectrum where primary signal and/or interference is strong, sub-carriers are selectively turned off; and/or
sub-carriers are selectively controlled to control aggregate interference by opportunistic use by the femto cell to primary signals.

14. The method as claimed in claim 12 and wherein a macrocellular network overlaying the femto cell is a narrowband cellular network.

15. The method as claimed in claim 14 and wherein the femto cell opportunistically re-uses non-contiguous frequency blocks of the macrocellular network.

16. The method as claimed in claim 2 and wherein a macrocellular network overlaying the femto cell is a narrowband cellular network and the femto cell opportunistically re-uses non-contiguous frequency blocks of the macrocellular network

17. The method as claimed in claim 1 and including using a signalling protocol between the femto cell and an end user to provide at least one of: control channels to convey multi-carrier system specific parameters; power control information; pilot information; paging information; messaging information; and synchronization information.

18. A femto base station for supporting a femto cell and configured to provide opportunistic use of the spectrum by the femto cell.

19. The femto base station as claimed in claim 18 and wherein opportunistic use includes at least one of: multi-operator spectrum re-use; and multi-service spectrum re-use.

20. The femto base station as claimed in claim 18 and comprising: a spectrum decision processor for using information from multiple operators regarding their spectrum utilization to determine available spectrum for opportunistic use by the femto cell.

21. The femto base station as claimed in claim 18 and including an air-interface between an end user and the femto cell, the air-interface using non-contiguous orthogonal frequency-division multiplexing (NC-OFDM).

22. The femto base station as claimed in claim 15 and wherein the femto cell is configured to opportunistically re-use non-contiguous frequency blocks of a narrowband macrocellular network overlaying the femto cell.

23. A multi-operator spectrum server, for use with a femto base station for supporting a femto cell and configured to provide opportunistic use of the spectrum by the femto cell, the server comprising: a collector configured to collect information about use of spectrum by multiple operators; and a processor for using the collected information to determine the aggregate spectrum available for opportunistic reuse by the femto cell; and a communicator for communicating the determination to permit opportunistic use of the spectrum by the femto base station.

24. The server as claimed in claim 23 and wherein the communicator communicates the determination to at least one of the femto base station and a femto controller.

25. The server as claimed in claim 24 and comprising a spectrum assessor for using information from a plurality of femto base stations to derive dynamic inferences about spectrum usage and availability.

26. A femto controller for coordinating operation of a plurality of femto base stations of an operator comprising:
a coordinator for coordinating opportunistic spectrum usage by femto cells supported by the plurality of femto base stations;
and a server for providing information to a femto base stations including at least one of: spectrum usage of neighboring femto cells; power levels of neighboring femto cells; locations of macro-cell base stations; and transmitters of primary users.

27. A spectrum usage decision processor, for use with a femto base station for supporting a femto cell, to determine available spectrum for opportunistic use by the femto cell, comprising using in the determination at least one of information about: type of primary user; type of primary user signals; locations of primary user transmitters; localized spectrum sensing to detect presence or absence of primary transmissions and/or presence of other secondary femto cells; information from other sensors or neighbor femto base stations on their real-time measurements spectral energy present in a band; signal specific characteristics; and detection of known signatures.

28. The processor as claimed in claim 20 and comprising a mapper to provide a spectrum band null map.
